(19) United States
(12) Patent Application Publication
(10) Pub. No.: US 2009/0240855 A1
(43) Pub. Date: Sep. 24, 2009

(54) METHOD AND APPARATUS FOR CONTROL IN RECONFIGURABLE ARCHITECTURE

(75) Inventors: Gaby Guri, Oranit (IL); Doron Solomon, Holon (IL)

Correspondence Address: MCDERMOTT WILL & EMERY LLP, 28 STATE STREET, BOSTON, MA, 02109-1775, US

(73) Assignee: ASOCS LTD., Rosh Haayin (IL)

(21) Appl. No.: 12/413,012

(22) Filed: Mar. 27, 2009

Related U.S. Application Data
(63) Continuation-in-part of application No. 11/649,146, filed on Jan. 2, 2007.
Application No. 11/649,146 is a continuation-in-part of application No. 11/071,340, filed on Mar. 3, 2005, now Pat. No. 7,568,059.
(60) Provisional application No. 61/040,106, filed on Mar. 27, 2008.

(51) Int. Cl. G06F 13/42

(52) U.S. Cl. 710/105

(57) ABSTRACT

An apparatus and method for control in a reconfigurable architecture is shown and described. In one example, an integrated circuit configured to implement a plurality of communications standards includes a plurality of upper level controllers and a plurality of lower level controllers. The upper level controller are configured to operate according to a portion of a communications standard and implement upper level control functions for the associated standard. The low level controllers are capable of communicating with each of the upper level controllers and can be assigned to each of the upper level controls to implement low level functions of each of the plurality of communications standards.

### RELATED APPLICATIONS

This application claims the benefit of U.S. Provisional Application No. 61/040,106 Filed Mar. 27, 2008 entitled “Method and Apparatus for Control in Reconfigurable Architecture”, and is a continuation-in-part of U.S. application Ser. No. 11/649,146, filed Jan. 2, 2007 in the name of Gaby Guri and Doron Solomon and directed to a System For And Method Of Hand-off Between Different Communication Standards, which in turn is a continuation-in-part of U.S. application Ser. No. 11/071,340 filed Mar. 3, 2005 in the name of Doron Solomon and Gilad Garon, published as United States Patent Published Application No. 2006/0010272 (Jan. 12, 2006) and directed to a Low-Power Reconfigurable Architecture For Simultaneous Implementation Of Distinct Communication Standards, all of said applications being assigned to the current assignee, and the disclosure of each of which is entirely incorporated herein by reference

### TECHNICAL FIELD

The present subject matter relates to techniques and equipment relating to wireless communications. More specifically, the subject matter relates to communications equipment and techniques capable to support multiple wireless standards.

### BACKGROUND

Known approaches to the design of reconfigurable architectures assume flexibility for allowing independent parallel implementations of distinct algorithms using the same hardware. In most of the cases the processing units of such architectures are capable of implementing and/or running several tasks, so that there is a transition from one task to another by a clear time-division shift from one task to the next with the corresponding partition between the two imposed by a central control element or adaptive control taking into account possible preferences among the tasks. Reconfigurable modems require a different approach.

Indeed, most of the time a reconfigurable modem only needs to implement one standard, and the implementation assumes implementation of intermediate configuration states in such a way so as to allow implementation of the standard with fewer resources. However, where the modem is designed to simultaneously implement more than one standard, each of the standards requires implementation of its own set of intermediate states of configuration allowing implementation of each standard with restricted resources. Such a situation occurs, for example, when implementing a vertical hand-off between two distinct standards, and the modem is required to keep simultaneous connectivity in both standards for a specific amount of time. In such a case, each standard implemented requires independent task management. In order to simultaneously implement both standards during such times, processing units usually have to be shared between the standards. This requirement makes implementation of the control difficult, and significantly increases the complexity of the control functions in the device, leads to an increase in the size of memories and other resources, thus affecting the efficiency and size of the device. Another problem follows from a large number of conditions to satisfy the requirements of each of the standards being processed in parallel, and therefore yielding a computationally heavy control decision function depending on comparison and weighing parameters characterizing distinct standards. Complexity of the cumbersome control leads to increased time of debugging and bug propagations.

FIG. 1 illustrates a standard architecture currently in use for certain modems. Generally, the architecture includes design processing units of different types (e.g., types A-N). In order to implement a standard using this architecture, processing units are partly employed. Each processing unit typically includes at least one control unit and at least one arithmetic unit. The control unit may be a processor or a simple state machine. In some configurations it is noteworthy that no control unit is required. Alternatively, all control functions can be concentrated in an external control unit. An external control unit would communicate with all or some processing units. Usually the external control unit is generally used to control the main and upper layers of decisions.

Whenever a device needs to implement a number of communication standards, running in parallel, and independently (unsynchronized), a number of the processing units will implement tasks from a particular standard, while other processing units will be assigned to more than one standard. The control functions of the units implementing tasks from different standards are quite complicated due to the necessity of implementing tasks which are not synchronized, and the timing and resources cannot be predicted. The same is true for an external controller, which has to work with two independently running protocols, and has to optimize the interaction between units.

### SUMMARY

The teachings herein alleviate one or more of the above noted problems. The proposed architecture described herein, partitions the common control of the two standards of interest (the architecture can partition the common control of more than two standards, but for simplicity we will describe only a case of two) to two independent programs, with a minimal level of connection between them. Such an arrangement allows for a simplification of the control function, and simplifies the development process of the controlling program, and its debugging. One approach includes an additional “upper” layer that controls the processing units along with their control units. It is suggested that for each standard there will be assigned the “upper” controller (one or several) that will take all decisions about control of the elements that are assigned to it. The upper control unit is also allowed to “liberate” a processing unit assigned to it, and transfer it to the control of another upper level control unit. As such, the upper control units are connected so that they are able to communicate among themselves. At each time instant every processing unit is assigned to at most one upper control unit. In such an arrangement, the designer of standard implementation is free of considerations regarding another standard, and makes decisions independently.

In addition to having an upper layer, there is also a need that each of the processing units includes at least one arithmetic element (possibly different from unit to unit, according to tasks) and at least one “lower layer” control element. An independent lower layer control element allows independent functioning of each processing unit, and correspondingly its independent programming design and structure.

In one example, a method of implementing a plurality of communications standards within a single integrated circuit is disclosed. The method includes partitioning the control function of each of the plurality of standards into an upper level control function and a plurality of lower level control functions and associating the upper level control function for each of the plurality of standards with a respective upper level controller. The method also includes associating one or more of the plurality of lower control functions with a respective upper level controller to facilitate execution of a lower level function of one of the plurality of communications standards.

In another example, an integrated circuit configured to implement a plurality of communications standards includes a plurality of upper level controllers and a plurality of lower level controllers. The upper level controller are configured to operate according to a portion of a communications standard and implement upper level control functions for the associated standard. The low level controllers are capable of communicating with each of the upper level controllers and can be assigned to each of the upper level controls to implement low level functions of each of the plurality of communications standards.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a block diagram of an embodiment of a prior art reconfigurable modem.

FIG. 2A is a conceptual block diagram showing the assignment of various upper level and lower level controllers to various standards.

FIG. 2B is a conceptual block diagram showing the reassignment of various upper level and lower level controllers to various standards.

FIG. 3 is a block diagram of an embodiment of a control system of the present disclosure.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The various examples disclosed herein relate to portioning the control function of various wireless communication standards into upper layer control elements and lower layer control elements. As such, multiple standards can be support on a single integrated circuit and operate independently one another.

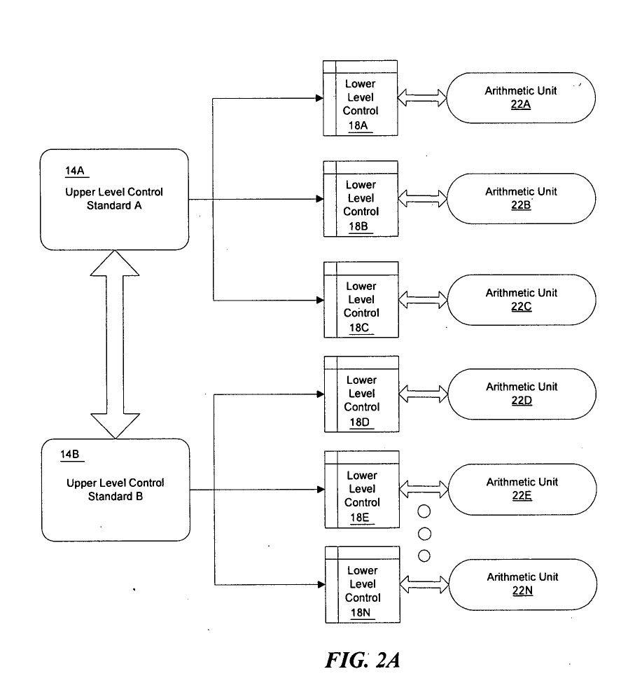

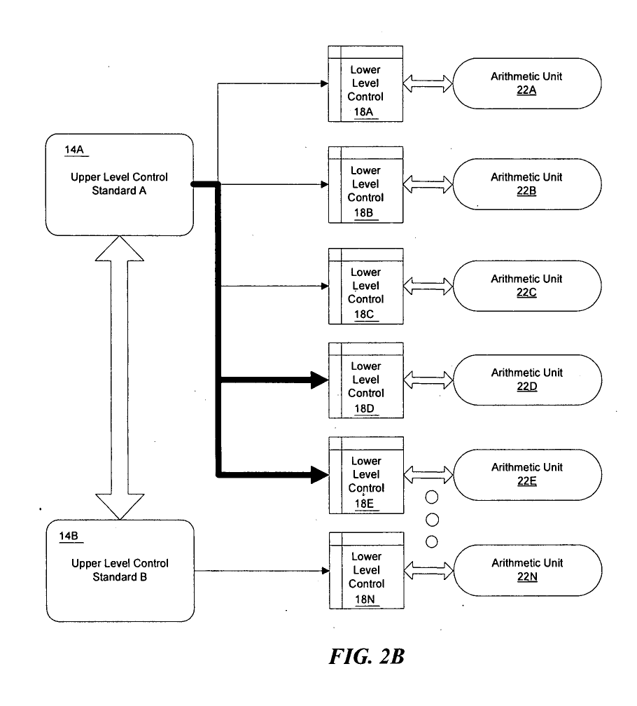

Reference now is made in detail to the examples illustrated in the accompanying drawings and discussed below. FIG. 2A depicts a control scheme 10 for a reconfigurable architecture that can be used in an integrated circuit. In some applications, the control scheme 10 can be applied to a reconfigurable modem to enable support for one or more wireless communication standards (e.g., 802.11, Bluetooth, 802.16, GSM, GPRS, EV-DO, and the like). The control system 10 includes an upper level controllers 14A, 14B, . . . 14N (referred to generally as upper level controller 14) and lower level controllers 18A, 18B, . . . , 18N (referred to generally as lower level controller 18). The upper level controllers 14 can communicate with each of the lower level controller 18 and each of the upper level controllers 14 as well. Each lower level controller is associated with an arithmetic unit 22A, 22B, . . . , 22N (referred to generally as arithmetic unit 22).

Each upper level controller 14 is generally assigned to implement a single wireless standard. As shown in FIG. 2A, upper level controller 14A is configured to implement a first wireless standard (e.g., Wi-Fi) and upper level controller 14B is configured to implement a second wireless standard (e.g., GSM). The upper level controller assigns tasks associated with its respective standard to one or more of the lower level controllers 18. As such, each upper level controller 14 exhibits control over one or more lower level controllers 18 and by extension the respective lower level controller's 18 arithmetic unit 22. Examples of upper layer control functions include, but are not limited to decoding, encoding, and controlling state machines associated with a respective standard, and the like. Typically, the upper level controllers 14 handle functionality related to the various PHY layer requirements of the wireless communication standards.

The lower level controller 18 performs the tasks assigned to it by the upper level controllers 14. Each lower level controller 18 can be associated with each of the upper level controllers 14 at various times. Said another way, in one instance lower level controller 18A is associated with executing a task assigned by upper level controller 14A according to the first wireless standard. After completion of the assigned task, lower level control 18A is returned to the pool of “free” lower level controllers 14 and can be assigned at another time to upper level controller 14B to perform tasks associated with the second wireless communications standard. Functionality provided by the various lower level controllers 18A include, but are not limited to executing fast Fourier transforms, random number generation, inverse fast Fourier transforms, addition, subtraction, filtering, correlating, and the like. Typically, the lower level controllers 18 handle functionality related to the various PHY layer requirements of the wireless communication standards. The lower level controllers 18 and the upper level controllers 14 cooperate, in some examples, to provide the PHY layer functionality of the wireless communications standards.

The arithmetic unit 22, in one example, is an arithmetic logic unit (ALU). The ALU performs calculations and logical operations on data received by the ALU. For example, if the ALU is a two's compliment type ALU it, and can perform operations such as integer arithmetic operations (e.g., addition, subtraction, multiplication and division), bitwise logic operations (e.g., AND, NOT, OR, and XOR), and bit-shifting operations (e.g., shifting or rotating a word by a specified number of bits to the left or right, with or without sign extension). In addition to two's complement type ALUs, other types (e.g., one's complement, sign-magnitude format, and true decimal systems, with ten tubes per digit) can be used. In addition to using ALUs, floating point units (FPUs) can also be used alone or in combination with ALUs.

As an operational example that highlights the various features and aspects of the present disclosure reference is made to FIG. 2A and FIG. 2B. As shown, the control functionality is partitioned into an upper layer control 14 and a lower layer control 18. As shown below, segmenting the control of the wireless standards in this manner simplifies the control functionality required when supporting multiple wireless communications standards within a single integrated circuit. For example, an integrated circuit that provides modem functionality for a plurality of standards can be achieved. Further, the need to synchronization operations among the standards can be reduced if not eliminated.

FIG. 2A and FIG. 2B reference an example supporting two wireless networking standards simultaneously, as for example when a vertical hand off occurs. It should be understood that more than two standards can be supported using the techniques described herein. As shown in FIG. 2A, a first upper level control 14A is operating according to a first standard. Upper level control 14A has assigned tasks to three lower level controls 18A, 18B, 18C and their associated arithmetic units 22A, 22B, 22C. A second upper level control 14B operates according to a second standard. The second upper level control 14B has assigned task to three lower level controls 18D, 18E, 18N and their respective arithmetic units 22D, 22E, 22N. Upon completion of the tasks assigned by the second upper level control 14B, two lower level controls 18D, 18E are freed from the second upper level control 14B.

Referring to FIG. 2B, the first upper level control 14A determines that additional lower level control is needed in accordance with the first standard. For example, it may be necessary to compute a Fourier transform. As a result, the first upper level control 14A assigns new tasks to two additional lower level controls 18D, 18E. In this example, the newly assigned lower level controls 18D, 18E were previously executing tasks associate with the second standard.

Although not shown in FIG. 2A and FIG. 2B, an external controller can also be include in the control system 10. The external controller partitions the resources in time domain, however in order to implement each standard it communicates, in one example, only with one upper layer controller corresponding to each standard. Therefore, the control signals for each standard are not synchronized with control signals intended for other standards. The information needed to control each standard arrives from the corresponding upper layer control unit. This again highlights the simplification and non-conflicting control system 10 of the present disclosure.

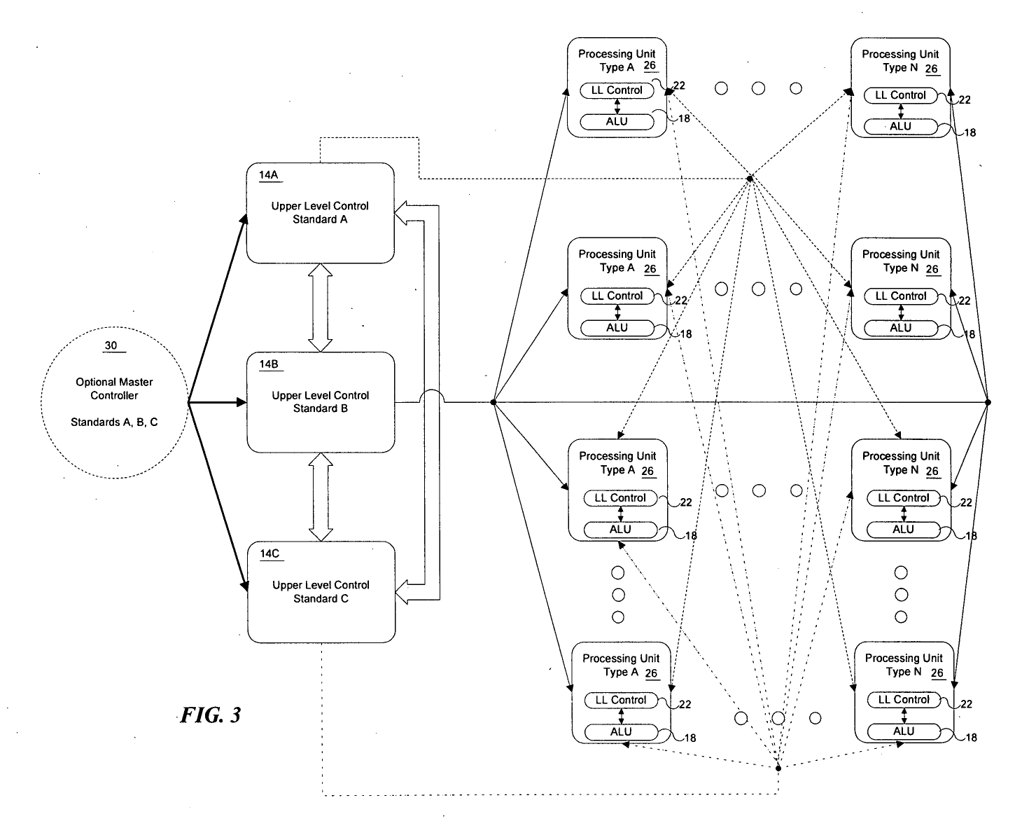

Referring now to FIG. 3, another block diagram of an architecture for a two-layered control system 10 is shown and described. One example, control system 10 includes a first upper level control 14A, a second upper level control 14B, and a third upper level control 14C. Each of the upper level controls 14 can communicate with one another. Also, each of the upper level controls 14 is able to communicate with a plurality of processing units. As shown, there are a number of different processing unit 26 types and there can be a plurality of each of the types of processing units 26 included in the control system 10. Examples of processing unit types include, but are not limited to, digital signal processors, central processing units, microprocessors, and others types of units that have the ability to perform mathematical operations. Each of the processing unit types includes a lower level control 14 and an arithmetic unit 22.

In some examples, an optional master controller 30 is provided. The master controller 30 communicates with the upper level controls 14. The master controller 30 controls the upper level controllers 14 and by extensions controls connections between the upper level controls 14 and processing units 26. In some examples, the master controller is external to the integrated circuit containing the other elements shown. In other examples, the master controller 30 is part of the same integrated circuit as the other elements. Functionality provided by the master controller 30 includes, but is not limited to, message queuing, message splitting, define transmission rates, assemble data blocks for transmission, and the like. Typically, the master controller 30 handles functionality related to the various MAC layer requirements of the wireless communication standards.

In operation, each of the upper level controllers 14A, 14B, 14C, is associated with a specific wireless communication standard. For example, the first upper level controller 14A is associated with Bluetooth, the second upper level controller is associated with Wi-Fi, and the third upper level controller 14C is associate with a cellular standard such as GSM. During operation of a device (e.g., a cellular phone or personal digital assistant), the various standards may be in operation at the same time. For example, the end-user may be using a Bluetooth headset while making a GSM telephone call. During such time, various processing units 26 are assigned and reassigned to the various upper level controllers 14 as needed. If during the call, the end-user comes into range of a Wi-Fi network and wishes to transition the call to a Wi-Fi type call (e.g. a Vonage type call), the handoff from GSM to Wi-Fi occurs. During the handoff, various processing units are assigned and reassigned to the various upper level controllers 14 to ensure proper functionality to the end-user.

### EXAMPLES

The following examples highlight features and advantages of the technology disclosed and are not intended to limit the claims in any fashion.

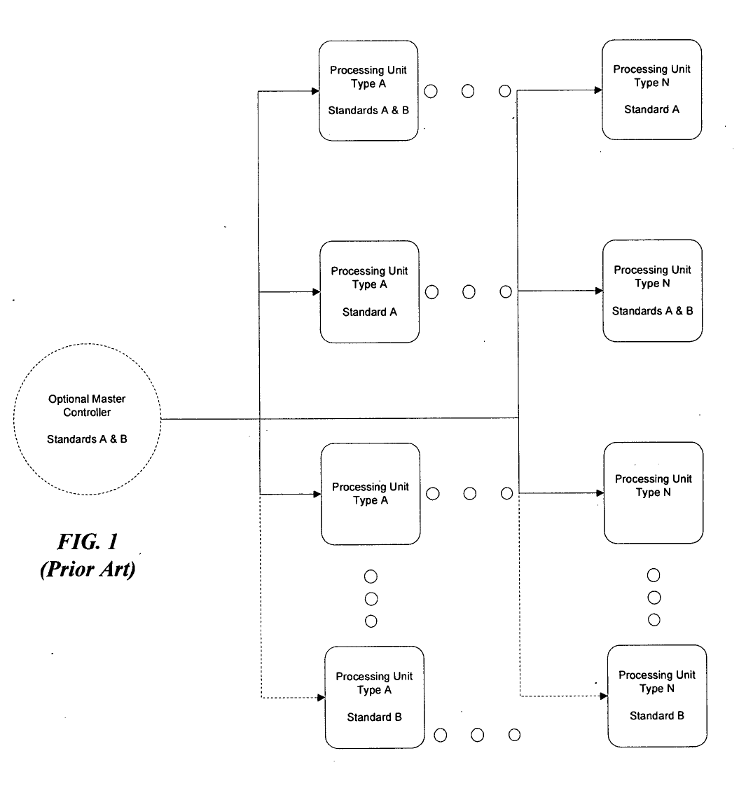

In a first example, the difference between the concept presented on FIG. 1 and that shown and described in FIG. 3 is described. Assume that one configuration intends to implement one or more of WLAN standards (e.g., 802.11a/b/g) and the GSM standard using the same platform. Each of the standards assumes possibilities of working in one of three possible modes, namely, transmit, receive, and sniffing for GSM, and in WLAN they are different for each one of the standard modifications (a, b, or g). To execute according to any of the standards, there is a need to transition among the states. One method of achieving this is through the use of a state machine, specific for the particular standard. Using these assumptions, there are six states of the machine in every standard. Clearly, the more granularity there will be more states in the machine.

The WLAN standard works independently of GSM. Therefore, the transfer between different modes in each one of the standards does not require any synchronization between the two.

In the using the prior art platform shown in FIG. 1, the central controller provides control over two standards simultaneously. Therefore, it is supposed to make relevant decisions, which requires analysis of all possible combinations of the modes in the two standards, namely a total of thirty-six states. This requires a highly complicated decision mechanism, which becomes extensively cumbersome when the number of the states in each one of the standards grows. Moreover, usually the command from the controller not only instructs on passing from one state to another, but also provides modified parameters to blocks at the lower level. All this requires a complicated designs based on exact analysis of all possible combinations of the states, which is often unpractical.

Another solution for control implementation is complete separation between two machines implementing the standards, along with separation of the control. Thus, each one of the machines will be controlled by an individual controller. However, this solution does not have advantages of reconfigurability.

Comparing the above with the example of FIG. 3 reveals that the use of an additional layer of controllers intended to control processing elements in the lower level provides a number of advantages. As shown in FIG. 3, the optional central controller 30 sends instructions to the next layer in the way it would do in the solution for separated implementations of the standards. These intermediate processing elements are partitioned to two subsets, such that each of the subsets implements one standard only (i.e., upper layer controllers). Now, for simplicity, let us assume that each one of the standards requires only one processing element to control the standard. In such an example these processing elements will be dealing with only six states and will be working independently of the second processing element. As well, it is assumed that the resources in the lower level are shared, so as to provide the advantage of reconfigurability. Each one of the intermediate processors decides what resources it needs and selects them from the then available resources in the lower level. At this stage each of the lower level blocks is attached to one of the intermediate control blocks. Each of the intermediate control blocks exchange information with the others to mutually check the resources available. Though it provides extra work, there is still an advantage of having only 6 states in each of the machines and faster reaction. Indeed, both allow faster independent and parallel change of the state (there are only 6 states in each). This described approach allows a significant simplification of the way systems are designed, since the design is done for each of the standards is done mostly independently.

In another example, it assumed that there are two different standards to be implemented, for instance LTE (Long Term Evolution) and WIMAX. Assume further that all the resources of the device are used for transmission using one of the standards (e.g., WIMAX). This means that in the upper level control of only one standard and all or almost all of the resources of the lower level are implementing tasks for this standard—for the full data rate bandwidth. When there is a necessity to pass to the second standard (vertical handoff), the resources (and the data rate/bandwidth) of the first standard are decreased. In turn, a number of the blocks in the lower level are freed from the previous tasks and can be devoted to implementation of the second standard—LTE, with restrictions allowing not to use the totality of the resources of the device and as a result not implementing the full data rate/bandwidth. This situation describes a parallel implementation of two standards with resource sharing. Whenever, the communication link corresponding to the LTE standard has been established in a stable mode, there appears a possibility to give up on the link corresponding to the WIMAX standard, and to transfer all the available resources to the LTE standard communication, in both, the lower and upper levels. At this moment the system can devote all the lower level resources for implementation of LTE standard requiring the most elaborated version of LTE.

The above control system 10 can be embodied in one or more integrate circuits. For example, the control system can be an application specific integrate circuit and a field programmable gate array. The circuits can be constructed using know techniques such as deposition, lithography, imaging, and etching. The resulting circuit can be packaged using any of the known types of integrate circuit packaging techniques such as flip-chip ball grid array package, ball grid array packaging, pin grad array packaging, leadless chip carrier packaging, and the like.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A method of implementing a plurality of communications standards within a single integrated circuit, comprising:
partitioning the control function of each of the plurality of standards into at least one upper level control function and a plurality of lower level control functions;
associating the upper level control function for each of the plurality of standards with a respective upper level controller; and
associating one or more of the plurality of lower control functions with a each upper level controller to facilitate execution of the lower level functions of the corresponding communications standard.

2. The method of claim 1 further comprising reassociating a previously associated one or more of the plurality of lower control functions to another upper level controller to facilitate execution of a lower level function of another one of the plurality of communications standards.

3. The method of claim 1 further comprising associating the upper level controllers with a master controller within the same integrated circuit.

4. The method of claim 1 further comprising associating the upper level controllers with a master controller external to the integrated circuit.

5. The method of claim 1 wherein execution of a lower level control function comprises executing the lower level control function by an arithmetic unit associated with the lower level control function.

6. An integrated circuit configured to implement a plurality of communications standards comprising:
a plurality of upper level controllers, each upper level controller configured to operate according to a portion of a communications standard and implement upper level control functions for that standard; and
a plurality of low level controllers capable of communicating with each of the upper level controllers and being assigned to each of the upper level controls to implement low level functions of a corresponding one of the communications standards.

7. The integrated circuit of claim 6 further comprising a master controller in communication with each of the plurality of upper level controllers.

8. The integrated circuit of claim 7 wherein the master controller is external to the integrated circuit.

9. The integrated circuit of claim 6 wherein the integrated circuit comprises an application specific integrated circuit.

10. A system for implementing a plurality of communications standards, comprising:
means for partitioning the control function of each of the plurality of standards into an upper level control function and a plurality of lower level control functions;
means for associating the upper level control function for each of the plurality of standards with a respective upper level controller; and
means for associating one or more of the plurality of lower control functions with a respective upper level controller to facilitate execution of a lower level function of one of the plurality of communications standards.

11. The system of claim 10 further comprising means for reassociating a previously associated one or more of the plurality of lower control functions to another upper level controller to facilitate execution of a lower level function of another of the plurality of communications standards.

12. The system of claim 10 further comprising means for associating the upper level controllers with a master controller within the same integrated circuit.

13. The system of claim 10 further comprising means for associating the upper level controllers with a master controller external to the integrated circuit.

14. The system of claim 10 where the wherein execution of a lower level control function comprises executing the lower level control function by arithmetic means associated with the lower level control function.
